(19) United States
(12) Patent Application Publication
(10) Pub. No.: US 2014/0372220 A1
(43) Pub. Date: Dec. 18, 2014

(54) Social Media Integration for Offer Searching

(71) Applicant: Target Brands, Inc., Minneapolis, MN (US)

(72) Inventors: Sarah Roxanne Peterson, St. Paul, MN (US); Amber Marie Reimer, Minneapolis, MN (US); Joel Michael Seeger, Minneapolis, MN (US); Trinath Subudhi, Minnetonka, MN (US); Benjamin Joseph DuPont, Pittsburgh, PA (US)

(21) Appl. No.: 13/916,107

(22) Filed: Jun. 12, 2013

(51) Int. Cl. G06Q 50/00; G06Q 30/02

(52) U.S. Cl. CPC G06Q 50/01; G06Q 30/0257
USPC 705/14.55

(57) ABSTRACT

A list of offers that match search criteria provided by a searcher is retrieved and a list of social media site contacts that are linked to the searcher on a social media site is requested. For each offer in the list of offers, a quantity of qualified selections of the offer is determined. The quantity of qualified selections for an offer comprises a quantity of users in the list of social media site contacts who are registered users of an offer selection application and who selected the offer using the offer selection application. The list of offers is ordered based on the quantities of qualified selections to produce an ordered list of offers and a user interface is provided that displays the ordered list of offers.

### BACKGROUND

Retailers publish discounts and sales offers on the Internet. Consumers can select an offer and use it during an electronic transaction or print the offer and redeem it during a transaction at a physical store.

“Social media” includes a collection of Internet and/or cellular network technologies that allow people to share information about their lives. In many of these technologies, a list of friends or followers is associated with a particular user such that when the user updates information about their lives, their friends or followers are notified. In some social media settings, when a user takes an action on an Internet page, that action is automatically updated on the user's social media postings so that their friends and followers are made aware of the user's actions.

The discussion above is merely provided for general background information and is not intended to be used as an aid in determining the scope of the claimed subject matter. The claimed subject matter is not limited to implementations that solve any or all disadvantages noted in the background.

### SUMMARY

A list of offers that match search criteria provided by a searcher is retrieved and a list of social media site contacts that are linked to the searcher on a social media site is requested. For each offer in the list of offers, a quantity of qualified selections of the offer is determined. The quantity of qualified selections for an offer comprises a quantity of people in the list of social media site contacts who are registered users of an offer selection application and who selected the offer using the offer selection application. The list of offers is ordered based on the quantities of qualified selections to produce an ordered list of offers and a user interface is provided that displays the ordered list of offers.

A computing device has a memory containing a user database holding information about users of an offer sharing site and an offer database holding information about offers provided by vendors on the offer sharing site. A processor receives credentials for a consumer on a social media site and uses the credentials to request a list of friends for the consumer from the social media site. The processor receives the list of friends for the consumer from the social media site and searches the user database to identify a subset of friends on the list of friends that also are users of the offer sharing site. The processor receives a query from the consumer and performs a search of the offer database to locate offers that satisfy the query. The processor generates a user interface that displays a list of offers that satisfy the query while highlighting at least one offer that satisfies the query and was selected by at least one friend in the subset of friends.

A storage medium has computer-executable instructions stored thereon that when executed by a processor, cause the processor to perform steps. The steps include retrieving a group of discounts and requesting a list of subscribers associated with a consumer from a social media site. At least one discount of the group of discounts is then displayed such that a discount that has been selected by a subscriber in the list of subscribers is highlighted.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of elements used in embodiments described below.

FIG. 2. is a flow diagram of a method of providing offer search results.

FIG. 3 is an example of a search user interface.

FIG. 4 is an example of a search results user interface with predictive search terms.

FIG. 5 is an example of a search result user interface with friend-selected offers highlighted.

FIG. 6 is an example of a user interface showing selected offers.

FIG. 7 is a block diagram of a computing environment that may be used in the various embodiments.

### DETAILED DESCRIPTION

A system is provided in which a consumer may search for offers made available by various vendors. Upon receiving the search query from the consumer, the system locates offers that match the query and then determines which of those offers have previously been selected by the consumer's contacts on one or more social media sites. Those offers that have been previously selected by a social media contact are highlighted when the offers are provided to the consumer in a search results user interface.

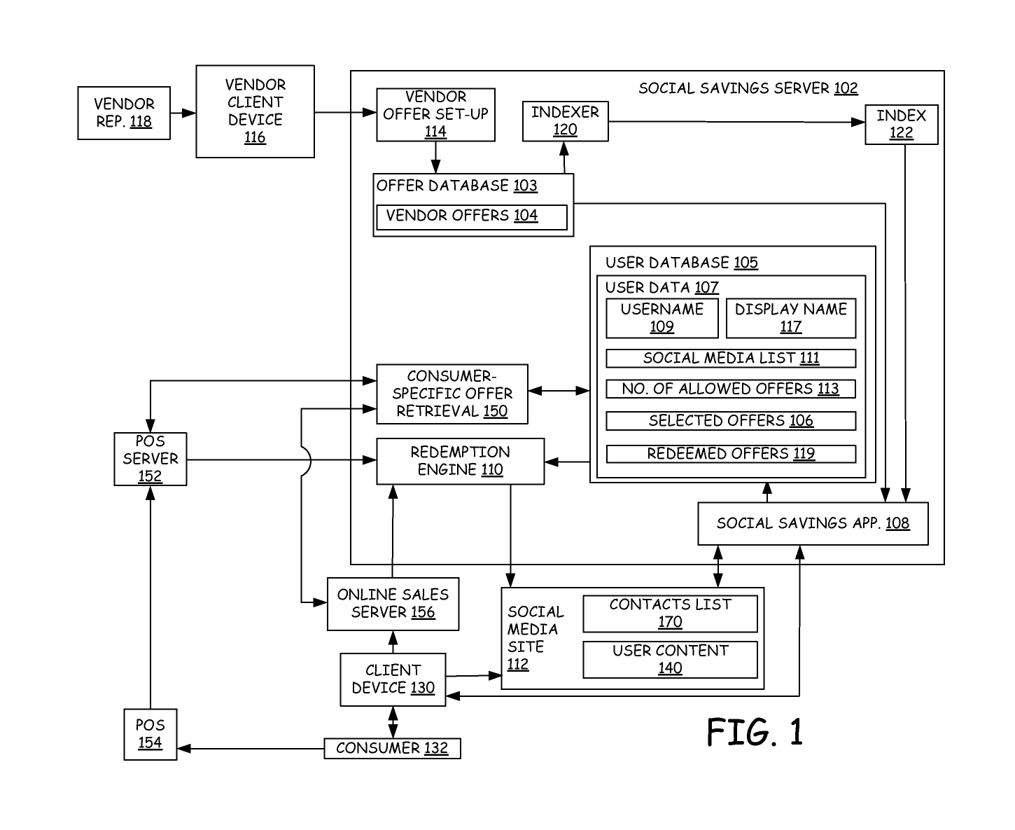

FIG. 1 provides a block diagram of elements used for setting, selecting, and redeeming offers in the context of an offer sharing system. In FIG. 1, a social savings server 102 provides user interfaces to allow vendors to create and store vendor offers 104. To create new offers, a vendor representative 118 uses a vendor client device 116 to interact with a vendor offer set-up application 114. Vendor offer set-up application 114 may take the form of a collection of webpages having code behind that allow the webpages to execute application functions and to store and retrieve data in offer database 103. Using the webpages provided by vendor offer set-up application 114, the vendor is able to provide a description of the offer, list the products associated with the offer, the expiration date of the offer and to designate an image or video that is to accompany the offer.

Upon receiving the offer information, vendor offer set-up application 114 stores the offer information in offer database 103 as one of vendor offers 104. Thus, offer database 103 holds information about offers or discounts provided by vendors. An indexer 120 creates an index 122 that is keyed by words and product names found in vendor offers 104. For each term/product name, index 122 provides a list of offers that contain that term or product name.

Social savings server 102 also includes a social savings application 108, which is an offer searching application, an offer selection application and an offer sharing application. Since social savings application 108 can be realized as a collection of web pages with code behind to allow it to perform various functions, social savings application 108 is also an offer searching site, and offer selection site and an offer sharing site. Index 122 may be searched using a search user interface provided by social savings application 108. In particular, social savings application 108 provides a search user interface to client device 130 that provides a text box where a consumer 132 may enter terms and product names to be searched. When consumer 132 submits a search query, social savings application 108 searches index 122 and retrieves all offers that match the search query. Social savings application 108 then returns the matching offers to client device 130 in a search results user interface.

Consumer 132 is able to select one or more of the offers in the search results user interface. When an offer is selected by consumer 132, social savings application 108 adds the offer to a user database 105. User database 105 is stored in memory and holds information about registered users of social savings application 108. In particular, for each user of social savings application 108, user database contains a user data record 107 that includes a username 109 that uniquely identifies the user on social savings application 108, a display name 117 to be displayed on user interfaces generated by social savings application 108, social media list 111 that lists social media sites associated with the user, selected offers 106, which is a set of offers, also referred to as a group of discounts, selected by the user for later redemption, number of allowed offers 113 representing the maximum number of offers allowed in selected offers 106 at any one time, and redeemed offers 119, which represents a set of offers that have been redeemed by the user in the past. When consumer 132 selects an offer, social savings application 108 adds the offer to selected offers 106 in the consumer's user data 107 of user database 105.

As noted in the description of database 105, the selection of an offer is different from the redemption of an offer. When an offer is selected, it is designated as being available to the consumer for later redemption. When an offer is redeemed, the discount provided by the offer is applied to the consumer's purchase to reduce the amount paid by the consumer. Once an offer is redeemed, it is removed from selected offers 106 and is added to redeemed offers 119.

Number of allowed offers 113 can be a constant number that is the same for all users of social savings application 108 or can be dynamic and user-specific such that it increases with certain actions of a user. For example, if a user invites social media contacts to join social savings application 108, the number of allowed offers 113 can be increased. In accordance with one embodiment, the number of allowed offers 113 is initially set to ten.

Consumer 132 may redeem an offer by going to a retail store or making an online purchase. When consumer 132 goes to a retail store, they select products from the shelves of the store and bring the products to a point-of-sale register 154 for checkout. During checkout, consumer 132 provides a consumer identifier (ID) to point-of-sale register 154. For example, consumer 132 can slide a credit card or savings card through a magnetic reader attached to point-of-sale register 154 and thereby transfer the consumer ID to point-of-sale register 154. In other embodiments, consumer 132 may provide their consumer ID using a radio frequency signal provided by a radio frequency transmitter held by consumer 132, providing a Bluetooth® signal through a handheld device held by consumer 132 or providing a signal over a wireless network through a handheld device held by consumer 132, for example. Point-of-sale register 154 provides the consumer ID to point-of-sale server 152, which then uses the consumer ID to request offers selected by the consumer associated with the consumer ID.

Specifically, point-of-sale server 152 passes the request to consumer-specific offer retrieval application 150, which accesses user database 105 to retrieve selected offers 106 for a username 109 that correlates to the consumer ID. In accordance with some embodiments, username 109 may not be the same as the consumer ID provided by consumer 132. In such cases, a mapping may occur in which the consumer ID provided by consumer 132 is converted into username 109 by one of point-of-sale register 154, point-of-sale server 152 or consumer-specific offer retrieval application 150. For example, a mapping table or a mapping algorithm may be used to convert a consumer ID provided at point-of-sale register 154 into a username as found in user database 105.

Consumer-specific offer retrieval application 150 returns selected offers 106 to point-of-sale server 152, which then forwards selected offers 106 to point-of-sale register 154. Point-of-sale register 154 compares the items listed in selected offers 106 to items being purchased in the current transaction. In order for point-of-sale register 154 to identify offers that are being redeemed, the offer information provided by consumer-specific offer retrieval application 150 should identify the products associated with an offer by, for example, providing a universal product code, a global trade item number, a stock keeping unit (SKU), or a retailer-specific identifier for the product. If items being purchased match items associated with one or more offers, each of the offers that match are designated as redeemed offers by point-of-sale register 154 and the offers are applied to the transaction to reduce the amount charged to consumer 132. Point-of-sale register 154 then indicates to point-of-sale server 152 which of selected offers 106 were redeemed. Point-of-sale server 152 provides information about the redeemed offers to redemption engine 110, which removes the redeemed offers from selected offers 106 and adds the redeemed offers to redeemed offers 119. Removing the redeemed offers from selected offers 106 and adding them to redeemed offers 119 can involve changing a status of the offers from “selected” to “redeemed” in user data 107.

A request for consumer-specific offers may also be provided by an online sales server 156 in response to a sales transaction between online sales server 156 and client device 130. Although client device 130 is shown as the same client device used to select offers, those skilled in the art will recognize that consumer 132 may use different client devices for selecting offers than for performing sales transactions with online sales server 156. For example, consumer 132 may use a handheld client device such as their phone for selecting offers and may use a second client device such as a laptop computer or tablet computer to perform sales transactions with online sales server 156.

Online sales server 156 receives a consumer ID from client device 130 and forwards the consumer ID to consumer-specific offer retrieval application 150 in a request for offers that have been selected by consumer 132. Online sales server may receive the consumer ID by having the consumer login to online sales server 156 using the consumer ID or by requesting the consumer ID from client device 130. Client device 130 may retrieve the consumer ID from a storage location on client device 130 or may request the consumer ID from consumer 132. In accordance with some embodiments, the consumer ID provided by client device 130 does not have to match username 109 stored in user database 105 for consumer 132. In such embodiments, online sales server 156 or consumer-specific offer retrieval application 150 may convert the consumer ID provided by client device 130 into username 109 using a mapping table or a mapping algorithm.

Consumer-specific offer retrieval application 150 retrieves selected offers 106 of user data 107 associated with the consumer ID. Consumer-specific offer retrieval application 150 returns the offer information for selected offers 106 to online sales server 156. Online sales server 156 identifies items that are being purchased and compares those items to items associated with the selected offers returned by consumer-specific offer retrieval application 150. Items that match a selected offer cause the selected offer to be designated as a redeemed offer, and the terms of the offer are applied to the purchase to reduce the amount charged to consumer 132.

Online sales server 156 then provides a list of redeemed offers to redemption engine 110. Redemption engine 110 updates selected offers 106 to remove the redeemed offers and adds the redeemed offers to redeemed offers 119 in user data 107. Removing the redeemed offers from selected offers 106 and adding them to redeemed offers 119 can involve changing a status of the offers from “selected” to “redeemed” in user data 107.

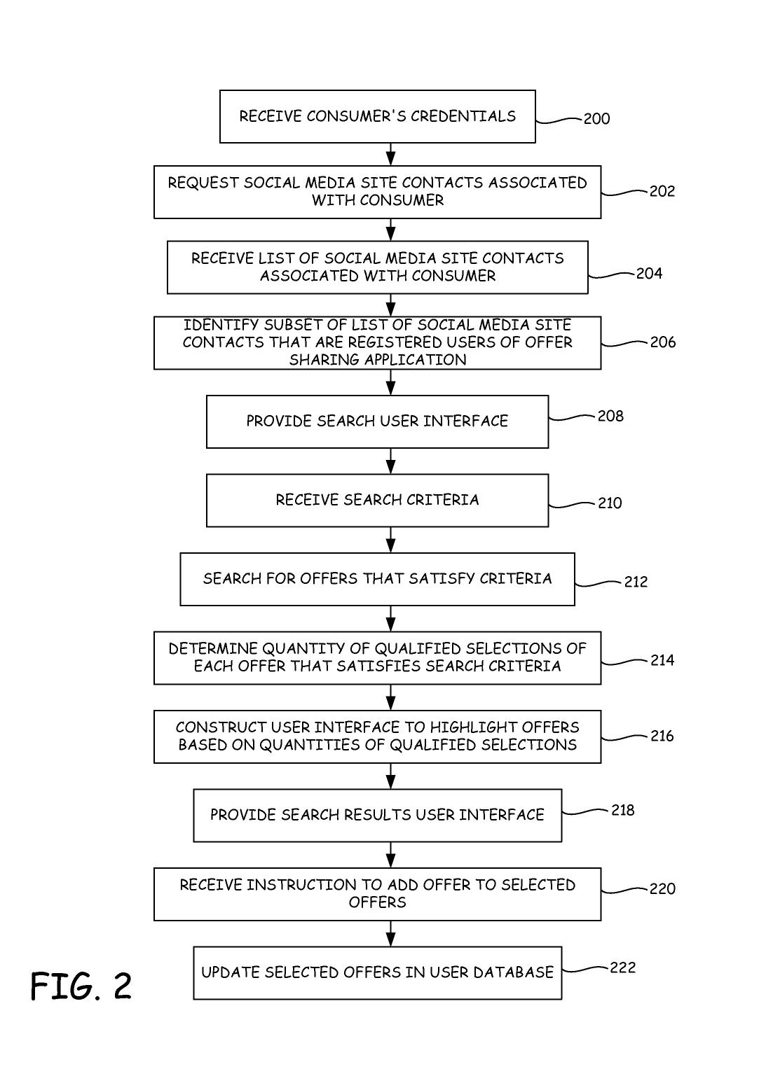

FIG. 2 provides a flow diagram of a method of soliciting and receiving search parameters for offers and returning offers that satisfy the search parameters. At step 200, user credentials of a consumer 132 are received by a social savings application 108. These user credentials may be received in response to a login screen sent to client device 130 by social savings application 108. The user credentials include a username such as an e-mail address and a password. The user credentials provided to social savings application 108 may be the same user credentials used to access a social media site 112. Thus, consumer 132 may have the same username on social savings application 108 and on social media site 112. In accordance with some embodiments, a login screen provided by social media site 112 is presented to client device 130 and consumer 132 logs into the social media site 112 through social savings application 108. Social media site 112 then returns the username for the consumer to social savings application 108 as the user credentials. Thus, social media site 112 and social savings application 108 use the same username for the same consumer 132 in accordance with some embodiments.

At step 202, social savings application 108 requests social media site contacts, also referred to as friends or subscribers, associated with or linked to the consumer from one or more social media sites. For example, social savings application 108 requests social media site contacts 170 from social media site 112. Social media site contacts can include, for example, people listed as “friends” or “followers” of the consumer on the social media site or anyone that the consumer is “following.” In general, any person that receives content concerning consumer 132 through the social media site or any person that consumer 132 receives content about through the social media site may be considered one of consumer 132's contacts (friends) on the social media site. Social media site contacts (friends) associated with consumer 132 may also include site visitors that have been granted access to user content, such as user content 140, associated with consumer 132. Such access is often granted by consumer 132 through a user interface provided by the social media site. The content provided by the social media site can include text, images, and video, for example.

To request the social media contacts, social savings application 108 first retrieves social media sites associated with consumer 132 from social media list 111 of user data 107. Social media list 111 may include a single social media site or multiple social media sites. Note that in embodiments in which each user is assumed to use the same social media site(s), this step is not needed. Social savings application 108 then retrieves login credentials for consumer 132 on each of the social media sites. In accordance with some embodiments, each entry in social media list 111 includes credentials for the consumer on a social media site such as a username and password of the consumer on the social media site to allow social savings application 108 to retrieve the consumer's contacts on the social media site. In other embodiments, the login credentials for the consumer on the social media site(s) are the same as the login credentials of the consumer on social savings application 108. In accordance with embodiments in which the consumer logs into the social media site as part of logging into social savings application 108, the consumer's credentials are provided by the social media site. After receiving the credentials for the consumer on the social media site(s), social savings application 108 uses the credentials to request the list of contacts for the consumer from the social media site(s).

At step 204, social savings application 108 receives the list(s) of social media site contacts associated with consumer 132 from the social media site(s). This list may take the form of usernames for the social media site contacts on the social media sites.

At step 206, social savings application 108 identifies a subset of the social media site contacts returned at step 204 that are registered users of social savings application 108. To identify which of the social media site contacts are registered users of social savings application 108, social savings application 108 searches for the social media site contacts in user database 105. In accordance with embodiments where social media site usernames are stored as part of social media list 111, social savings application 108 searches for the usernames of the social media site contacts in the social media list 111 of each user of social savings application 108. In accordance with embodiments where the social media site username is the same as the social savings application username, social savings application 108 searches for the usernames of the social media site contacts in the username 109 field of each user of social savings application 108. The contacts that are found through this search form a subset of the social media site contacts returned by the social media site(s). This subset of social media contacts can also be referred to as a subset of friends in the list of friends returned by the social media site(s).

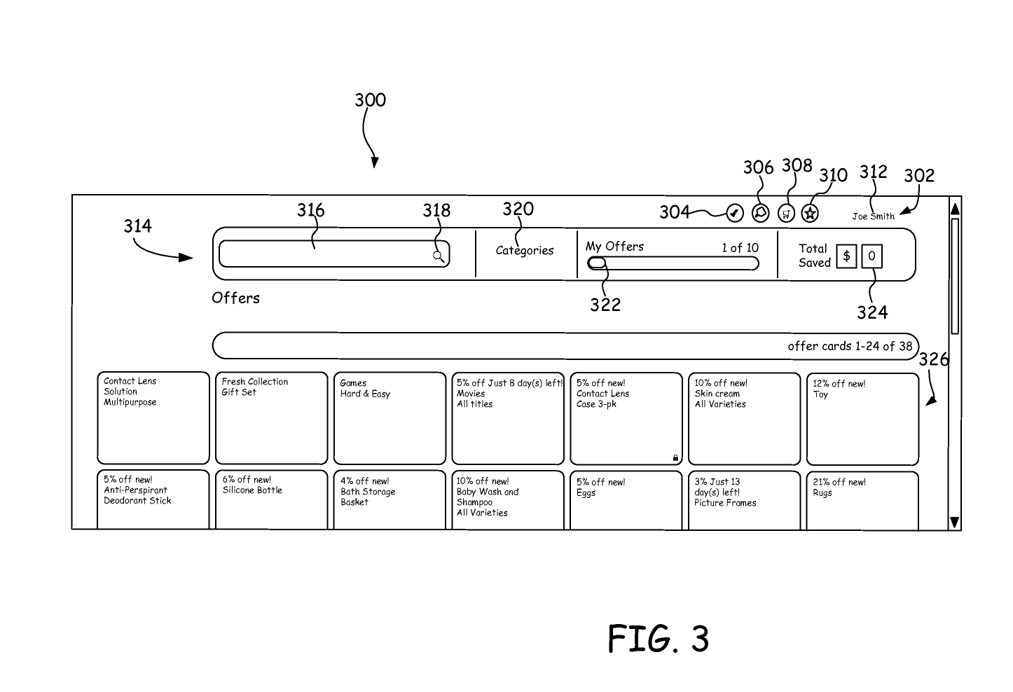

At step 208, social savings application 108 provides a search user interface to consumer 132 through client device 130. FIG. 3 provides an example of a search user interface 300 provided by social savings application 108.

Search user interface 300 includes a top banner 302 having a “My Offers” icon 304, a notifications icon 306, a “My Barcodes” icon 308, a collections icon 310, and a display name 312. “My Offers” icon 304 provides a link to a page displaying all offers that are currently selected by the consumer. Notifications icon 306 provides a link to a page providing messages about actions taken by other users of social savings application 108, such as which offers have been selected by other users and which offers have been redeemed by other users. “My Barcodes” icon 308 provides a link to a page that contains a list of products associated with barcodes that the consumer has captured on their mobile device. Collections icon 310 provides a link to a page containing collections of offers that have been selected by social media contacts of the consumer. Display name 312 is the display name of the consumer as found in display name 117 of user data 107.

Search user interface 300 also includes an intermediate banner 314 containing a search box 316, a search icon 318, a “Categories” pull-down menu 320, a “My Offers” meter 322, and a savings total 324. Search box 316 accepts search text from the consumer that is used to search for offers. When search icon 318 is selected by the consumer the search text in search box 316 is submitted to social savings application 108. When “Categories” pull-down menu 320 is selected by the consumer, a menu containing selectable categories of offers is displayed. In accordance with one embodiment, the categories include product categories such as food, electronics, toys, and clothing. “My Offers” meter 322 displays a graph indicating the number of offers that have been selected by the consumer relative to the number of offers the consumer is allowed to select. “My Offers” meter 322 also includes a textual indication of the number of offers the consumer has selected out of the number of offers the consumer is allowed to select. Savings total 324 indicates a dollar amount that the consumer has saved using the social savings system of FIG. 1. This value is updated each time the consumer redeems an offer.

Search user interface 300 also includes a list of offer cards 326 that are presented by default on search user interface 300. These default offer cards can be offers that vendors paid a premium to appear as default offers or can be offers that the social savings application 108 believes would be of interest to the consumer based on the consumers past offer selections.

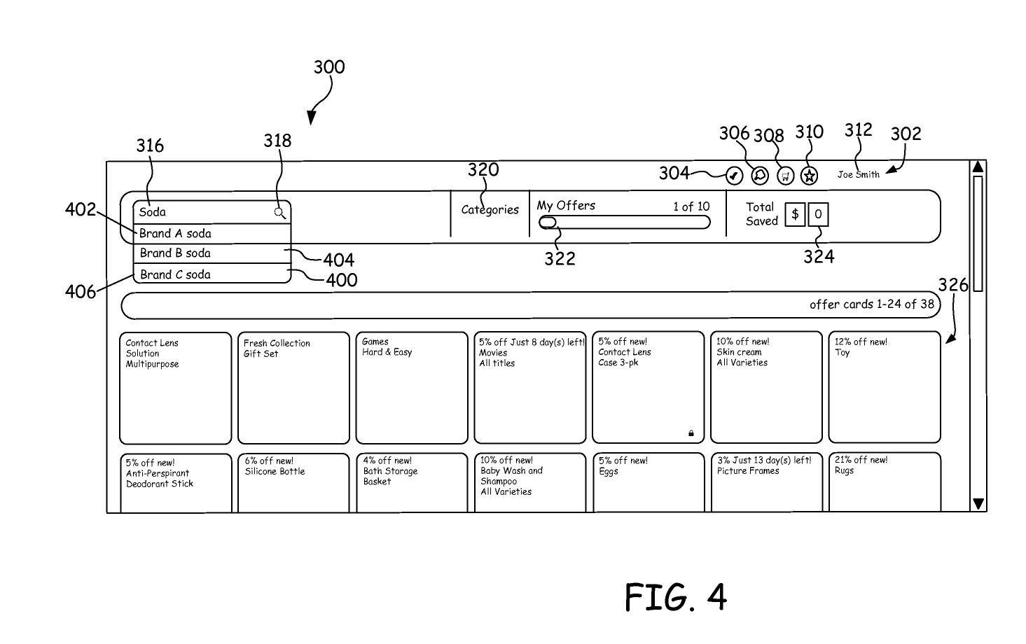

FIG. 4 provides an example screenshot of search user interface 300 taken as a consumer or searcher enters search text in search box 316. In accordance with one embodiment, search user interface 300 provides predictive searching where the contents of search box 316 is provided to social savings application 108 each time a character is added or removed from search box 316. Social savings application 108 then searches index 122 for terms that match the current content of search box 316 and returns the matching terms to search user interface 300. Search user interface 300 is then augmented with a search prediction box 400 that contains the matching terms, such as matching terms 402, 404 and 406. Each of the terms in prediction box 400 is selectable such that if selected, the term is placed in search box 316 and the term is submitted as the search text to social savings application 108. Social savings application 108 then performs a search to find offers that match the term.

Returning to FIG. 2, at step 210, social savings application 108 receives the search criteria or query entered into search textbox 316 when the consumer, who is considered a searcher in this context, selects search icon 318, hits an enter key or selects a search term from a search prediction box. At step 212, social savings application 108 performs a search of offer database 103 by searching index 122 to locate offers that satisfy the search criteria or query.

At step 214, for each offer that social savings application 108 locates that satisfies the search criteria, social savings application 108 determines a quantity of qualified selections of the offer. A qualified selection of an offer is an offer that was selected by one of the subset of the consumer's social media site contacts that are registered users of the social savings application 108. In other words, a qualified selection of an offer is a selection of an offer made by a “friend” or “follower” of consumer 132 on a social media site such as social media site 112. Since more than one of consumer 132's social media contacts may have selected an offer, the number of social media contacts who have selected the offer is counted to form the quantity of qualified selections for the offer, also referred to as a count for the offer.

To determine the quantity of qualified selections of an offer, social savings application 108 searches for each offer in the selected offers 106 of each of the consumer's social media contacts.

At step 216, social savings application 108 constructs a user interface to return offers that satisfy the search criteria while highlighting offers based on the quantities of qualified selections for the offers. Highlighting the offers based on the quantities of qualified selections can include bolding offers that have at least one qualified selection, color coding offers based on the quantities of qualified selections and/or setting the order of offers in the user interface so that offers with the highest number of qualified selections appear first in the search results. In accordance with some embodiments, an offer is considered to be first in a list of vertically displayed search results if it is at the top of the list of search results, and is considered to be first in a list of horizontally displayed search results if it is on the leftmost side of the list. For search results that are returned as a set of rows, an offer is considered to be first in the list if it is in the upper-left corner of the rows of offers.

At step 218, social savings application 108 provides a search result user interface to client device 130 that allows consumer 132 to select one or more of the offers found through the search.

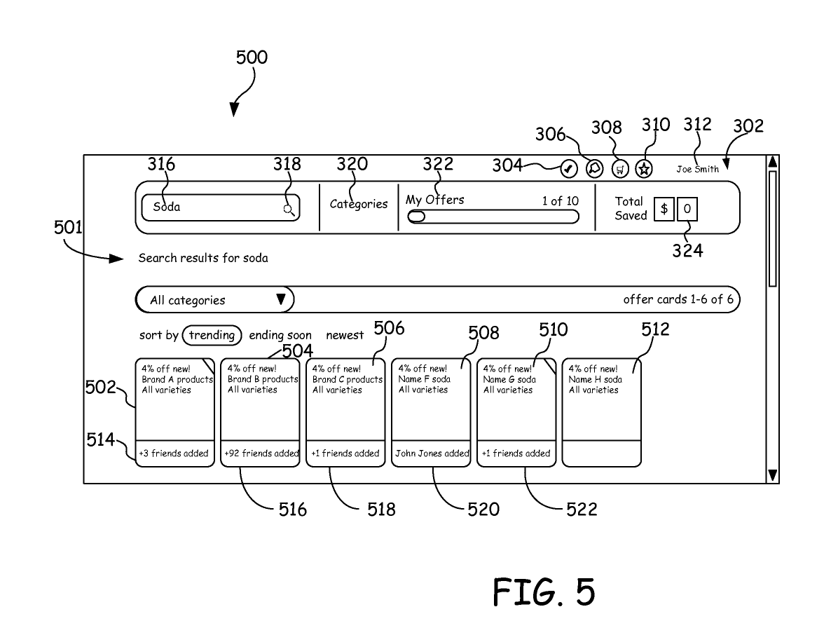

FIG. 5 provides an example of a search results user interface 500 in which offers are highlighted based on the quantities of qualified selections by setting the order of the offers in the user interface. Like FIGS. 3 and 4, search results user interface 500 of FIG. 5 includes top banner 302 with “My Offers” icon 304, notifications icon 306, “My Barcodes” icon 308, collections icon 310, and a display name 312. User interface 500 also includes intermediate banner 314 containing search box 316, search icon 318, “Categories” pull-down menu 320, “My Offers” meter 322, and savings total 324. In addition, search results user interface 500 includes search header 501, which indicates that this is a search results page that provides offers that match the submitted search query. Search results user interface 500 also includes offer cards 502, 504, 506, 508, 510 and 512, each representing offers that satisfy the previously submitted search query. In accordance with one embodiment, the offer cards in search results user interface 500 are returned as a set of rows.

In FIG. 5, each offer card includes an indication of how many social media contacts have selected each offer. For example, indication 514 of offer card 502 indicates that three social media contacts have previously selected the offer associated with offer card 502. Similarly, offer cards 504, 506, 508 and 510 have respective indications 516, 518, 520, and 522 that indicate the count or number of contacts who have selected those offers. Offer card 512 does not have an indication that a social media contact has selected the offer because no social media contacts have selected that offer. Indications 514, 516, 518, and 522 provide a number of contacts who have selected the offer while indication 520 provides a username of a single contact who has selected the offer.

In FIG. 5, the offer cards are ordered based on the number of qualified selections of each offer. Thus, offer card 502, which was previously selected by the most social media contacts is shown in the upper-left position of the returned offers. Offer card 504, which was selected by the second highest quantity of social media contacts is shown to the immediate right of offer card 504. Offer cards 506, 508 and 510, which have been selected by fewer social media contacts than offer card 504, are shown to the right of offer card 504. Offer card 512, which has not been selected by at least one social media contact is shown to the right of the offer cards that were selected by at least one social media contact.

At step 220, consumer 132 indicates that they want to add one of the offers returned in the search results user interface to their set of selected offers 106 and this indication is received by social savings application 108. At step 222, social savings application 108 adds the offer to the set or group of selected offers 106 for consumer 132.

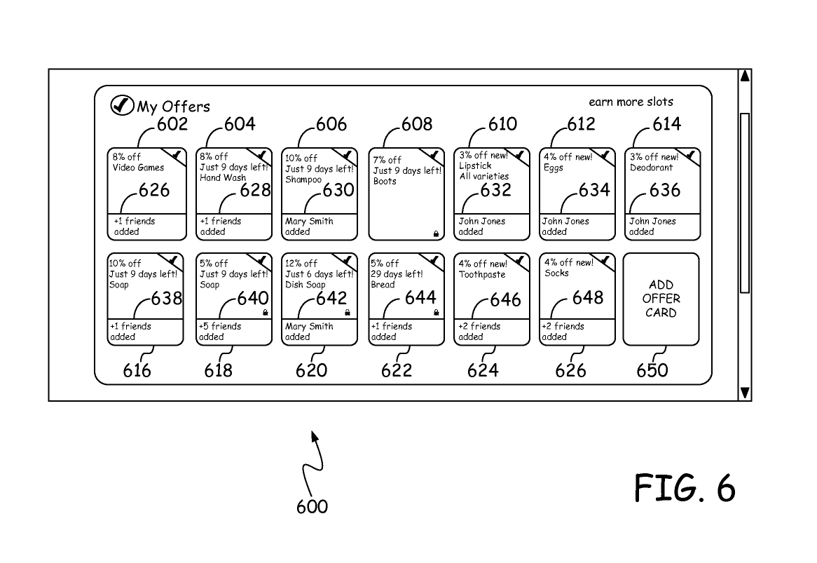

FIG. 6 provides an example of a “My Offers” or selected-offers user interface 600 that displays selected offers 106 in response to a consumer selecting “My Offers” link 304 in search user interface 300. In selected-offers user interface 600, offer cards 602, 604, 606, 608, 610, 612, 614, 616, 618, 620, 622, 624 and 626, each represent one of selected offers 106. Offer cards 602, 604, 606, 610, 612, 614, 616, 618, 620, 622, 624 and 626 include respective indications 626, 628, 630, 632, 634, 636, 638, 640, 642, 644, 646, and 648 that indicate that the offers have been selected by at least one of the consumer's social media contacts. Indications 626, 628, 638, 640, 644, 646, and 648 indicate a quantity of social media contacts that have selected the offer. Indications 630, 632, 634, 636, and 642 provide usernames of social media contacts that have selected the offer. Selected-offers user interface 600 also includes an empty slot 650 that indicates that the consumer may select an additional offer to add to selected offers 106.

In accordance with embodiments described above, a social savings system is provided that is able to reorder offers provided in a search results page based on how many social media contacts of a consumer have previously selected the offers. This helps the consumer to select from available offers when the number of offers the consumer can select is limited. By being given the additional information that people in the consumer's social media network have previously selected an offer, the consumer is better able to determine if an offer is good enough to be added to their limited number of allowed offers.

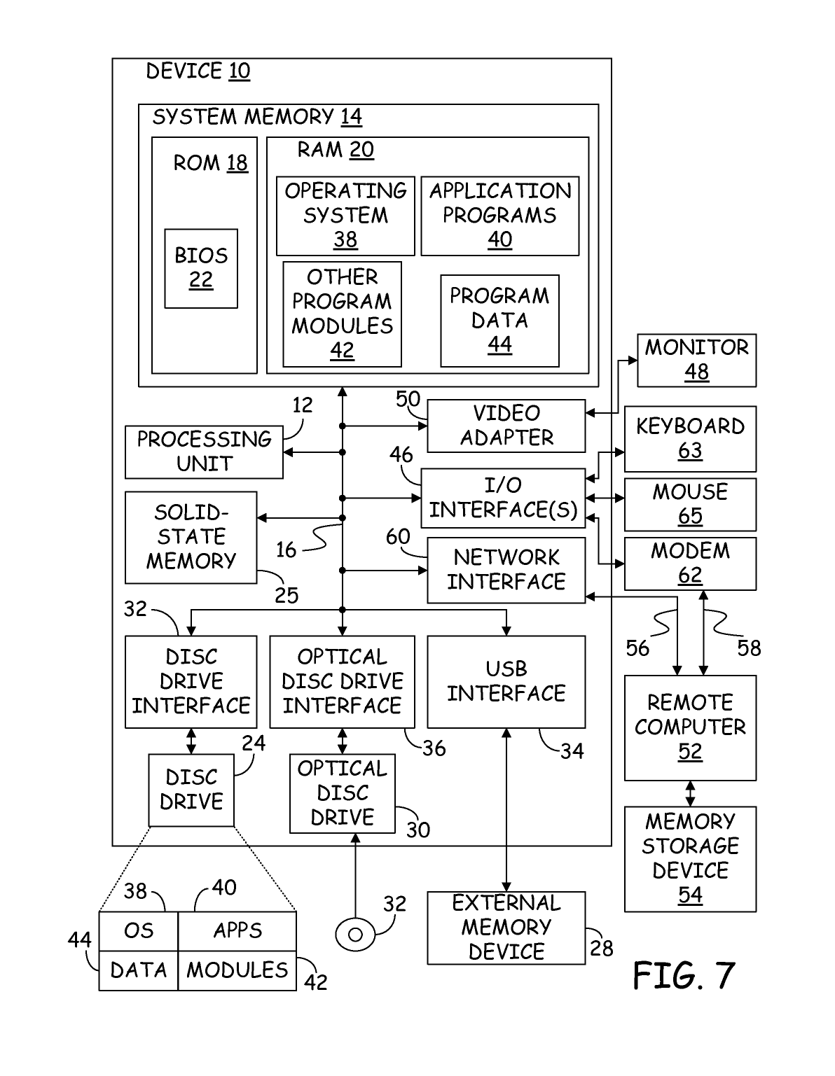

An example of a computing device that can be used as a server and/or client device in the various embodiments is shown in the block diagram of FIG. 7. The computing device 10 of FIG. 7 includes a processing unit 12, a system memory 14 and a system bus 16 that couples the system memory 14 to the processing unit 12. System memory 14 includes read only memory (ROM) 18 and random access memory (RAM) 20. A basic input/output system 22 (BIOS), containing the basic routines that help to transfer information between elements within the computing device 10, is stored in ROM 18.

Embodiments of the present invention can be applied in the context of computer systems other than computing device 10. Other appropriate computer systems include handheld devices, multi-processor systems, various consumer electronic devices, mainframe computers, and the like. Those skilled in the art will also appreciate that embodiments can also be applied within computer systems wherein tasks are performed by remote processing devices that are linked through a communications network (e.g., communication utilizing Internet or web-based software systems). For example, program modules may be located in either local or remote memory storage devices or simultaneously in both local and remote memory storage devices. Similarly, any storage of data associated with embodiments of the present invention may be accomplished utilizing either local or remote storage devices, or simultaneously utilizing both local and remote storage devices.

Computing device 10 further includes a hard disc drive 24, a solid state memory 25, an external memory device 28, and an optical disc drive 30. External memory device 28 can include an external disc drive or solid state memory that may be attached to computing device 10 through an interface such as Universal Serial Bus interface 34, which is connected to system bus 16. Optical disc drive 30 can illustratively be utilized for reading data from (or writing data to) optical media, such as a CD-ROM disc 32. Hard disc drive 24 and optical disc drive 30 are connected to the system bus 16 by a hard disc drive interface 32 and an optical disc drive interface 36, respectively. The drives, solid state memory and external memory devices and their associated computer-readable media provide nonvolatile storage media for computing device 10 on which computer-executable instructions and computer-readable data structures may be stored. Other types of media that are readable by a computer may also be used in the exemplary operation environment.

A number of program modules may be stored in the drives, solid state memory 25 and RAM 20, including an operating system 38, one or more application programs 40, other program modules 42 and program data 44. For example, application programs 40 can include instructions for social savings application 108, consumer-specific offer retrieval application 150, redemption engine 110, vendor offer set-up application 114, indexer 120 and social media site 112. Program data 44 can include vendor offers 104, index 122, user data 107, selected offers 106, contacts list 170 and user content 140.

Input devices including a keyboard 63 and a mouse 65 are connected to system bus 16 through an Input/Output interface 46 that is coupled to system bus 16. Monitor 48 is connected to the system bus 16 through a video adapter 50 and provides graphical images to users. Other peripheral output devices (e.g., speakers or printers) could also be included but have not been illustrated. In accordance with some embodiments, monitor 48 comprises a touch screen that both displays input and provides locations on the screen where the user is contacting the screen.

Computing device 10 may operate in a network environment utilizing connections to one or more remote computers, such as a remote computer 52. The remote computer 52 may be a server, a router, a peer device, or other common network node. Remote computer 52 may include many or all of the features and elements described in relation to computing device 10, although only a memory storage device 54 has been illustrated in FIG. 7. The network connections depicted in FIG. 7 include a local area network (LAN) 56 and a wide area network (WAN) 58. Such network environments are commonplace in the art.

Computing device 10 is connected to the LAN 56 through a network interface 60. Computing device 10 is also connected to WAN 58 and includes a modem 62 for establishing communications over the WAN 58. The modem 62, which may be internal or external, is connected to the system bus 16 via the I/O interface 46.

In a networked environment, program modules depicted relative to computing device 10, or portions thereof, may be stored in the remote memory storage device 54. For example, application programs may be stored utilizing memory storage device 54. In addition, data associated with an application program may illustratively be stored within memory storage device 54. It will be appreciated that the network connections shown in FIG. 7 are exemplary and other means for establishing a communications link between the computers, such as a wireless interface communications link, may be used.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
retrieving a list of offers that match search criteria provided by a searcher;
requesting a list of site contacts that are linked to the searcher on a social media site;
for each offer in the list of offers, determining a quantity of qualified selections of the offer, wherein a quantity of qualified selections for an offer comprises a quantity of people in the list of site contacts who are registered users of an offer selection application and who selected the offer using the offer selection application;
ordering the list of offers based on the quantities of qualified selections to produce an ordered list of offers; and
providing a user interface displaying the ordered list of offers.

2. The method of claim 1 further comprising the offer selection application providing to a computing device a user interface that accepts search criteria from the searcher and receiving the search criteria provided by the searcher.

3. The method of claim 2 wherein requesting the list of site contacts comprises requesting the list of site contacts from the social media site before receiving the search criteria from the searcher.

4. The method of claim 3 wherein the list of site contacts that are linked to the searcher comprises people who receive content associated with the searcher through the social media site.

5. The method of claim 1 wherein the searcher has a same username on the offer selection application and the social media site.

6. The method of claim 1 further comprising receiving a selection of an offer from the searcher and adding the selected offer to a set of selected offers for the searcher.

7. The method of claim 6 wherein the searcher is allowed to have a limited number of selected offers in the set of selected offers at any one time.

8. The method of claim 6 further comprising displaying the set of selected offers in a selected-offers user interface such that the selected-offers user interface indicates that an offer was selected by the searcher and by at least one site contact linked to the searcher.

9. The method of claim 1 wherein ordering the list of offers comprises ordering the list of offers such that an offer with the highest quantity of qualified selections appears first in the ordered list of offers.

10. A computing device comprising:
a memory containing a user database holding information about users of an offer sharing site and an offer database holding information about offers provided by vendors on the offer sharing site;
a processor receiving credentials for a consumer on a social media site;
the processor using the credentials to request a list of friends for the consumer from the social media site;
the processor receiving the list of friends for the consumer from the social media site and searching the user database to identify a subset of friends on the list of friends that also are users of the offer sharing site;
the processor receiving a query from the consumer and performing a search of the offer database to locate offers that satisfy the query;
the processor generating a user interface that displays a list of offers that satisfy the query while highlighting at least one offer that satisfies the query and was selected by at least one friend in the subset of friends.

11. The computing device of claim 10 further comprising the processor searching the user database to identify offers selected by the subset of friends.

12. The computing device of claim 11 wherein highlighting at least one offer that satisfies the query and was selected by at least one friend in the subset of friends comprises ordering the displayed list of offers so that the at least one offer that satisfies the query and was selected by at least one friend in the subset of friends is first in the list.

13. The computing device of claim 12 further comprising the processor generating counts of the number of friends in the subset of friends who selected each offer in the list of offers that satisfy the query and ordering the offers in the list of offers that satisfy the query based on the counts.

14. The computing device of claim 13 further comprising:
receiving an indication that the consumer selected an offer in the list of offers; and
assigning the offer to a group of selected offers for the consumer wherein the group of selected offers is limited to a user-specific number of offers.

15. The computing device of claim 14 further comprising receiving a request to display the group of selected offers for the consumer and in response providing a user interface displaying the group of selected offers for the consumer such that the count of the number of friends in the subset of friends who selected an offer is displayed.

16. A storage medium having computer-executable instructions stored thereon that when executed by a processor, cause the processor to perform steps comprising:
retrieving a group of discounts;
requesting a list of subscribers associated with a consumer from a social media site;
receiving the list of subscribers from the social media site; and
displaying at least one discount of the group of discounts such that a discount that has been selected by a subscriber in the list of subscribers is highlighted.

17. The storage medium of claim 16 wherein retrieving a group of discounts comprises retrieving a group of discounts that meet search criteria provided by the consumer.

18. The storage medium of claim 16 further comprising determining which subscribers in the list of subscribers is registered to use a discount selection application.

19. The storage medium of claim 18 further comprising receiving an indication that the consumer has selected a highlighted discount and adding the discount to a list of discounts that have been selected by the consumer.

20. The storage medium of claim 19 wherein the number of discounts that may be added to the list of discounts that have been selected by the consumer is limited.
